(19) United States
(12) Patent Application Publication
(10) Pub. No.: US 2025/0026658 A1
(43) Pub. Date: Jan. 23, 2025

(54) SPHERICAL MAGNESIUM OXIDE AND METHOD FOR PRODUCING SAME, RESIN FILLER, AND RESIN COMPOSITION

(71) Applicant: Tateho Chemical Industries Co., Ltd., Hyogo (JP)

(72) Inventor: Akinori SAITO, Hyogo (JP)

(21) Appl. No.: 18/701,555

(22) PCT Filed: Oct. 14, 2022
(86) PCT No.: PCT/JP2022/038352

§ 371 Date: Apr. 15, 2024

(30) Foreign Application Priority Data
Oct. 15, 2021 (JP) 2021-169606

(51) Int. Cl. C01F 5/06; C08K 3/22; C08K 7/16

(52) U.S. Cl. CPC C01F 5/06; C08K 3/22; C08K 7/16; C01P 2004/03; C01P 2004/32; C01P 2004/51; C01P 2004/60; C01P 2006/12; C08K 2003/222; C08K 2201/003; C08K 2201/006

(57) ABSTRACT

The object of the present invention is to provide spherical magnesium oxide having high sphericity and excellent moisture resistance and filling properties in resin without including a certain amount of boron or lithium, and a method for producing the same. The present invention is spherical magnesium oxide having the total content of elements belonging to the 3rd to 4th periods of the periodic table (except for the elements belonging to the 2nd and 18th groups) and yttrium of 500 to 12,000 ppm, having a volume-based cumulative 50% particle diameter (D50) measured by a laser diffraction/scattering particle size distribution measurement of 1 to 200 μm, and wherein a sphericity read from a SEM photomicrograph of 1.00 to 1.20.

### TECHNICAL FIELD

The present invention relates to a spherical magnesium oxide having high sphericity and excellent moisture resistance, a method for producing the same, a resin filler including the spherical magnesium oxide, and a resin composition including the resin filler.

### BACKGROUND ART

Magnesium oxide has excellent electrical insulation, thermal conductivity, and heat resistance, and is used in various applications as an industrial material, including raw material for refractories, insulating material for heaters, abrasive material, vulcanization accelerator for rubber, and pigment for paints and inks. Magnesium oxide is also used as a resin filler for the purpose of imparting properties such as heat resistance to resins. In Patent Document 1, magnesium oxide is used to provide gas barrier properties to resin films used for packaging food and the like. In Patent Document 2, magnesium oxide is used as a white pigment to be added to resin. In Patent Document 3, magnesium oxide is used to improve the light resistance of resin. In Patent Document 4, magnesium oxide is used to improve the thermal conductivity of epoxy resin. However, when blended with resin, magnesium oxide is highly hygroscopic, and causes the problem of, for example, cracks due to volume expansion of filler caused by hydration with moisture in the air. Therefore, magnesium oxide with excellent moisture resistance that does not cause the above problems even during a long-term use is desired. Furthermore, when magnesium oxide is used as a resin filler, high filling properties in resin compositions are required to obtain excellent performance.

When magnesium oxide is used as a resin filler, it must be fillable and moisture resistant. Patent Document 5 proposes spherical magnesium oxide with a smooth and dense surface, obtained by adding a lithium compound. Patent Document 6 proposes spherical magnesium oxide with a smooth surface and excellent moisture resistance and filling properties, obtained by adjusting the content of boron and iron within a certain range. Patent Document 7 proposes spherical magnesium oxide which has excellent moisture resistance and provides fluidity when a resin composition is filled with the spherical magnesium oxide, obtained by adjusting the content of boron and lithium within a certain range.

### PRIOR ART DOCUMENTS

### Patent Document

Patent Document 1: JP2015-131494 A
Patent Document 2: JP2015-101614 A
Patent Document 3: JP2009-227725 A
Patent Document 4: JP2017-186578 A
Patent Document 5: JP2016-088838 A
Patent Document 6: JP2018-131378 A
Patent Document 7: WO 2020/203710

### SUMMARY OF INVENTION

### Technical Problem

However, although the spherical magnesium oxides obtained by the methods described above have improved moisture resistance and filling properties in resin, the content of boron and the content of lithium must be controlled. The high content of boron or lithium also reduces properties of magnesium oxide (insulation, heat resistance, and thermal conductivity), and these elements get easier to leach into resin, adversely affecting the performance of final products such as electronic devices. Furthermore, inclusion of lithium in magnesium oxide adversely affects the flowability of resin compositions when magnesium oxide is added to resin, and thus the content of lithium should be small. Thus, an object of the present invention is to provide spherical magnesium oxide having high sphericity and excellent moisture resistance and filling properties in resin without including a certain amount of boron or lithium, and a method for producing the same.

### Solution to Problem

The present inventors have conducted intensive studies to solve the above problem and have found that by adjusting the content of elements belonging to the 3rd to 4th periods of the periodic table (except for the elements belonging to the 2nd and 18th groups), spherical magnesium oxide having high sphericity and excellent moisture resistance and filling properties in resin can be obtained without including a certain amount of boron or lithium. The present inventors have also found that adjusting the content of yttrium in addition to the content of elements belonging to the 3rd to 4th periods of the periodic table (except for the elements belonging to the 2nd and 18th groups) is effective for preparing spherical magnesium oxide having high sphericity and excellent moisture resistance and filling properties in resin.

That is, the present invention relates to spherical magnesium oxide having the total content of elements belonging to the 3rd to 4th periods of the periodic table (except for the elements belonging to the 2nd and 18th groups) and yttrium of 500 to 12,000 ppm, having a volume-based cumulative 50% particle diameter (D50) measured by a laser diffraction/scattering particle size distribution measurement of 1 to 200 μm and a sphericity read from a SEM photomicrograph of 1.00 to 1.20.

The present invention also relates to spherical magnesium oxide having the total content of elements belonging to the 3rd to 4th periods of the periodic table (except for the elements belonging to the 2nd and 18th groups) of 500 to 12,000 ppm. having a volume-based cumulative 50% particle diameter (D50) measured by a laser diffraction/scattering particle size distribution measurement of 1 to 200 μm and a sphericity read from a SEM photomicrograph of 1.00 to 1.20.

The present invention also relates to a resin filler comprising the above spherical magnesium oxide.

The present invention also relates to a resin composition comprising the above resin filler.

The present invention also relates to a method for producing spherical magnesium oxide, comprising: 1) preparing a slurry of spherical magnesium carbonate by reacting an aqueous solution of magnesium salt and an aqueous solution of carbonate and coagulating the resulting magnesium carbonate: 2) preparing spherical magnesium carbonate particles by filtering the slurry of spherical magnesium carbonate, washing with water, and drying; and 3) preparing spherical magnesium oxide by firing the spherical magnesium carbonate particles, wherein in at least one of the steps 1) to 3), the amount of each element belonging to the 3rd to 4th periods of the periodic table (except for the elements belonging to the 2nd and 18th groups) and yttrium is adjusted so that the total content of the elements belonging to the 3rd to 4th periods of the periodic table (except for the elements belonging to the 2nd and 18th groups) and yttrium is 500 to 12,000 ppm in the spherical magnesium oxide after firing.

The present invention also relates to a method for producing spherical magnesium oxide, comprising: 1) preparing a slurry of spherical magnesium carbonate by reacting an aqueous solution of magnesium salt and an aqueous solution of carbonate and coagulating the resulting magnesium carbonate: 2) preparing spherical magnesium carbonate particles by filtering the slurry of spherical magnesium carbonate, washing with water, and drying; and 3) preparing spherical magnesium oxide by firing the spherical magnesium carbonate particles, wherein in at least one of the steps 1) to 3), the amount of each element belonging to the 3rd to 4th periods of the periodic table (except for the elements belonging to the 2nd and 18th groups) is adjusted so that the total content of the elements belonging to the 3rd to 4th periods of the periodic table (except for the elements belonging to the 2nd and 18th groups) is 500 to 12,000 ppm in the spherical magnesium oxide after firing.

### Advantageous Effects of Invention

The present invention can provide spherical magnesium oxide having high sphericity and excellent moisture resistance and filling properties in resin, and a method for producing the same.

### BRIEF DESCRIPTION OF DRAWINGS

FIG. 1 is a SEM photomicrograph of the spherical magnesium oxide of Example 1.

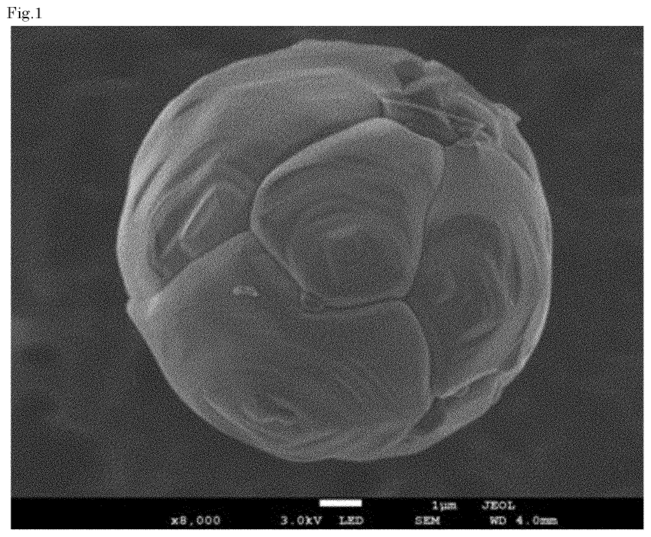

### DESCRIPTION OF EMBODIMENTS

In the spherical magnesium oxide of the present invention, the total content of elements belonging to the 3rd to 4th periods of the periodic table (except for the elements belonging to the 2nd and 18th groups) and yttrium is 500 to 12,000 ppm; and the spherical magnesium oxide of the present invention has a volume-based cumulative 50% particle diameter (D50) measured by a laser diffraction/scattering particle size distribution measurement of 1 to 200 μm and has a sphericity read from a SEM photomicrograph of 1.00 to 1.20.

Furthermore, in the spherical magnesium oxide of the present invention, the total content of elements belonging to the 3rd to 4th periods of the periodic table (except for the elements belonging to the 2nd and 18th groups) is 500 to 12,000 ppm; and the spherical magnesium oxide the present invention has a volume-based cumulative 50% particle diameter (D50) measured by a laser diffraction/scattering particle size distribution measurement of 1 to 200 μm and has a sphericity read from a SEM photomicrograph of 1.00 to 1.20. As used herein, ppm means ppm by mass unless otherwise specified.

In the present invention, spherical magnesium oxide having a volume-based cumulative 50% particle diameter (D50) measured by a laser diffraction/scattering particle size distribution measurement of 1 to 200 μm, a sphericity read from a SEM photomicrograph of as high as 1.00 to 1.20, and excellent moisture resistance can be obtained by adjusting the total content of elements belonging to the 3rd to 4th periods of the periodic table (except for the elements belonging to the 2nd and 18th groups) and yttrium to 500 to 12,000 ppm. The spherical magnesium oxide of the present invention has excellent filling properties in resin due to high sphericity.

In the present invention, spherical magnesium oxide having a volume-based cumulative 50% particle diameter (D50) measured by a laser diffraction/scattering particle size distribution measurement of 1 to 200 μm, a sphericity read from a SEM photomicrograph of as high as 1.00 to 1.20, and excellent moisture resistance can be obtained by adjusting the total content of elements belonging to the 3rd to 4th periods of the periodic table (except for the elements belonging to the 2nd and 18th groups) to 500 to 12,000 ppm. The spherical magnesium oxide of the present invention has excellent filling properties in resin due to high sphericity.

In the present invention, the elements belonging to the 3rd to 4th periods of the periodic table (except for the elements belonging to the 2nd and 18th groups) specifically refer to sodium, aluminum, silicon, phosphorus, sulfur, chlorine, potassium, scandium, titanium, vanadium, chromium, manganese, iron, cobalt, nickel, copper, zinc, gallium, germanium, arsenic, selenium and bromine. For example, the elements is preferably at least one selected from the group consisting of sodium, aluminum, silicon, phosphorus, chlorine, potassium and titanium, and more preferably at least one selected from the group consisting of aluminum, silicon, phosphorus and titanium. It is also preferable that the elements is at least one selected from the group consisting of aluminum, silicon and titanium. In the present invention, by adjusting the content of elements belonging to the 3rd to 4th periods of the periodic table, spherical magnesium oxide having excellent moisture resistance, high sphericity and a smooth surface can be obtained.

In the present invention, the total content of elements belonging to the 3rd to 4th periods of the periodic table (except for the elements belonging to the 2nd and 18th groups), for example, is 500 to 12,000 ppm, more preferably 500 to 10.000 ppm, and even more preferably 500 to 8.000 ppm. When the total content is less than 500 ppm, spherical magnesium oxide having excellent moisture resistance, high sphericity, and a smooth surface cannot be obtained. When the total content is 12,000 ppm or more, particles are likely to grow excessively and adhere to each other, and thus spherical magnesium oxide having high sphericity cannot be obtained.

In the spherical magnesium oxide of the present invention, the total content of, for example, sodium, aluminum, silicon, phosphorus, sulfur, chlorine, potassium, scandium, titanium, vanadium, chromium, manganese, iron, cobalt, nickel, copper, zinc, gallium, germanium, arsenic, selenium, bromine and yttrium is adjusted to a predetermined content (e.g., 500 to 12,000 ppm, preferably 500 to 10.000 ppm, and even more preferably 500 to 8.000 ppm). By doing so, spherical magnesium oxide having excellent moisture resistance, high sphericity, and a smooth surface can be obtained. It is also preferable to adjust the total content of aluminum, silicon, phosphorus, manganese, titanium, and yttrium to the above predetermined content in the spherical magnesium oxide of the present invention. Furthermore, for example, in the spherical magnesium oxide of the present invention, the total content of aluminum, silicon, phosphorus, manganese, and titanium may be adjusted to the above predetermined content, or the total content of aluminum, silicon, and titanium may be adjusted to the above predetermined content.

The spherical magnesium oxide of the present invention may contain a predetermined amount (e.g., 500 to 12,000 ppm, preferably 500 to 10.000 ppm, and even more preferably 500 to 8.000 ppm) of, for example, at least one selected from the group consisting of sodium, aluminum, silicon, phosphorus, sulfur, chlorine, potassium, scandium, titanium, vanadium, chromium, manganese, iron, cobalt, nickel, copper, zinc, gallium, germanium, arsenic, selenium, bromine, and yttrium. This provides spherical magnesium oxide having excellent moisture resistance, high sphericity, and a smooth surface. It is also preferable that the spherical magnesium oxide of the present invention contains at least one selected from the group consisting of aluminum, silicon, phosphorus, manganese, titanium, and yttrium in the above predetermined amount. Furthermore, the spherical magnesium oxide of the present invention may contain at least one selected from the group consisting of aluminum, silicon, phosphorus, manganese, and titanium in the above predetermined amount, and it may contain at least one selected from the group consisting of aluminum, silicon, and titanium in the above predetermined amount.

In the present invention, since spherical magnesium oxide having excellent moisture resistance, high sphericity, and a smooth surface can be obtained without including boron, the content of boron can be very small. Thus, the content of boron may be, for example, less than 10 ppm, preferably less than 9 ppm, and more preferably less than 8 ppm. Reduction in the content of boron reduces degradation of properties of magnesium oxide. Furthermore, since the elution of boron into resin can be reduced, errors in the electronic circuit can be reduced when the magnesium oxide is used in electronic devices.

In the present invention, since spherical magnesium oxide having excellent moisture resistance, high sphericity and a smooth surface can be obtained without including lithium, the content of lithium can be very small. Thus, the content of lithium may be for example, less than 15 ppm, preferably less than 10 ppm, and more preferably less than 5 ppm. Reduction in the content of lithium reduces degradation of insulation properties of magnesium oxide. Furthermore, since the elution of lithium into resin can be reduced, the performance degradation of final products can be reduced.

In the present invention, the content of calcium may be set to, for example, less than 700 ppm, preferably less than 600 ppm, and more preferably less than 500 ppm. When the content of calcium is 700 ppm or more, moisture resistance is likely to be reduced, and magnesium oxide having high sphericity is difficult to be obtained.

In the present invention, the spherical magnesium oxide has a volume-based cumulative 50% particle diameter (D50) measured by a laser diffraction/scattering particle size distribution measurement of 1 to 200 μm, more preferably 5 to 100 μm, and even more preferably 10 to 50 μm. Furthermore, the volume-based cumulative 50% particle diameter (D50) preferably ranges from 10 to 150 μm.

In the present invention, the spherical magnesium oxide has a sphericity read from a SEM photomicrograph of 1.00 to 1.20, preferably 1.00 to 1.15, and even more preferably 1.00 to 1.10, which can affect filling properties in resin. In the present invention, with respect to 100 particles in an electron photomicrograph taken by using a scanning electron microscope (SEM), lengths of a long diameter and a short diameter passing through the center of each particle are measured, and the ratio of the long diameter/the short diameter is calculated, and the average value is determined as sphericity.

The spherical magnesium oxide of the present invention has a BET specific surface area of, for example, 0.01 to 1.00 m²/g, more preferably 0.05 to 0.80 m²/g, and even more preferably 0.10 to 0.60 m²/g.

The method for producing the spherical magnesium oxide of the present invention is not particularly limited, and may be produced, for example, as described below.

1) A slurry of spherical magnesium carbonate is prepared by reacting an aqueous solution of magnesium salt and an aqueous solution of carbonate and coagulating the resulting magnesium carbonate:

2) spherical magnesium carbonate particles are prepared by filtering the slurry of spherical magnesium carbonate, washing with water, and drying; and

3) spherical magnesium oxide is prepared by firing the spherical magnesium carbonate particles in the air.

In the method, before the final firing, the amount of each element belonging to the 3rd to 4th periods of the periodic table (except for the elements belonging to the 2nd and 18th groups) and yttrium is adjusted by adding or mixing them so that the total content of the elements belonging to the 3rd to 4th periods of the periodic table (except for the elements belonging to the 2nd and 18th groups) and yttrium is 500 to 12,000 ppm in the spherical magnesium oxide after the final firing.

More specifically, the total content of elements belonging to the 3rd to 4th periods of the periodic table (except for the elements belonging to the 2nd and 18th groups) and yttrium in the spherical magnesium oxide finally obtained is adjusted, for example, by a) adding a compound containing the above element to an aqueous solution of magnesium salt and/or an aqueous solution of carbonate, b) adding a compound containing the above element to the resulting slurry of spherical magnesium carbonate, c) mixing a compound containing the above element to the resulting spherical magnesium carbonate particles, and the like.

Alternatively, the spherical magnesium of the present invention may be produced as described below.

1) A slurry of spherical magnesium carbonate is prepared by reacting an aqueous solution of magnesium salt and an aqueous solution of carbonate and coagulating the resulting magnesium carbonate:

2) spherical magnesium carbonate particles are prepared by filtering the slurry of spherical magnesium carbonate, washing with water, and drying; and

3) spherical magnesium oxide is prepared by firing the spherical magnesium carbonate particles in the air.

In the method, before the final firing, the amount of each element belonging to the 3rd to 4th periods of the periodic table (except for the elements belonging to the 2nd and 18th groups) is adjusted by adding or mixing them so that the total content of the elements belonging to the 3rd to 4th periods of the periodic table (except for the elements belonging to the 2nd and 18th groups) is 500 to 12,000 ppm in the spherical magnesium oxide after the final firing.

More specifically, the total content of elements belonging to the 3rd to 4th periods of the periodic table (except for the elements belonging to the 2nd and 18th groups) in the spherical magnesium oxide finally obtained is adjusted, for example, by a) adding a compound containing the above element to an aqueous solution of magnesium salt and/or an aqueous solution of carbonate, b) adding a compound containing the above element to the resulting slurry of spherical magnesium carbonate, c) mixing a compound containing the above element to the resulting spherical magnesium carbonate particles, and the like.

In this regard, as the compound added and mixed above, any compound may be used without limitation as long as it contains an element belonging to the 3rd to 4th periods of the periodic table (except for the elements belonging to the 2nd and 18th groups). As for yttrium, a compound containing yttrium may be used without limitation.

The aluminum source is not particularly limited as long as it is a compound containing aluminum, and for example, aluminum hydroxide, aluminum oxide, aluminum carbonate, aluminum chloride, aluminum nitrate, aluminum acetate, aluminum sulfate, and the like may be used.

The silicon source is not particularly limited as long as it is a compound containing silicon, and for example, silicon oxide, silicate, and the like may be used. Examples of silicon oxides include crystalline silica, amorphous fumed silica, and colloidal silica. Examples of silicates include sodium silicate, magnesium silicate, potassium silicate, and calcium silicate.

The phosphorous source is not particularly limited as long as it is a compound containing phosphorus, and for example, phosphoric acid phosphate, and the like may be used. Examples of phosphates include magnesium phosphate, sodium phosphate, potassium phosphate, and ammonium phosphate.

The chlorine source is not particularly limited as long as it is a compound containing chlorine, and examples thereof include sodium chloride, magnesium chloride, potassium chloride, and calcium chloride.

The bromine source is not particularly limited as long as it is a compound containing bromine, and examples thereof include sodium bromide, magnesium bromide, potassium bromide, and calcium bromide.

The sodium source is not particularly limited as long as it is a compound containing sodium, and examples thereof include sodium chloride, sodium carbonate, sodium phosphate, sodium hydroxide, and sodium nitrate.

The potassium source is not particularly limited as long as it is a compound containing potassium, and examples thereof include potassium chloride, potassium carbonate, potassium phosphate, potassium hydroxide, and potassium nitrate.

The titanium source is not particularly limited as long as it is a compound containing titanium, and examples thereof include titanium oxide (anatase type and rutile type), titanium chloride, titanium hydroxide, titanium bromide, titanium fluoride, and magnesium titanate.

The manganese source is not particularly limited as long as it is a compound containing manganese, and examples thereof include manganese dioxide, manganese hydroxide, manganese carbonate, manganese chloride, and manganese nitrate.

The yttrium source is not particularly limited as long as it is a compound containing yttrium, and examples thereof include yttrium oxide, yttrium chloride, and yttrium nitrate.

It is also preferable to control the content of boron to less than 10 ppm, the content of lithium to less than 15 ppm, and the content of calcium to less than 700 ppm in the spherical magnesium oxide after the final firing. The method for reducing the content of boron, the content of lithium, and the content of calcium is not particularly limited. For example, a known process may be used, such as repulp washing in which re-slurrying of precursor magnesium carbonate cake and water washing after filtration are repeated, pretreatment of an aqueous solution of magnesium salt using adsorbent, and adjustment of the profile of temperature increase in the firing, and these processes may be used in combination. Alternatively, the content of the above elements can be controlled to low levels by selecting raw materials which do not contain those elements and properly controlling the possibility of inclusion in the manufacturing process.

The magnesium salt in the above aqueous solution of magnesium salt is not particularly limited, and for example, a magnesium salt selected from magnesium chloride, magnesium nitrate, magnesium sulfate, magnesium acetate, and a combination thereof may be used.

The carbonate in the above aqueous solution of carbonate is not particularly limited. and for example, a carbonate selected from sodium carbonate, potassium carbonate, ammonium carbonate, and a combination thereof may be used.

The concentration of magnesium salt in the aqueous solution of magnesium salt is preferably 1 to 30% by mass. The concentration of carbonate in the aqueous solution of carbonate is preferably 1 to 30% by mass. The reaction between the aqueous solution of magnesium salt and the aqueous solution of carbonate may be performed, for example, under conditions in which the ratio of the concentration of ions [Mg²⁺]: [CO₃²⁻] is 1.2:1 to 1:1.5.

In the method for producing the spherical magnesium oxide of the present invention, first an aqueous solution of magnesium salt and an aqueous solution of carbonate are reacted, and then the resulting magnesium carbonate is coagulated to give a slurry of spherical magnesium carbonate. At that stage, magnesium carbonate produced by the reaction between the aqueous solution of magnesium salt and the aqueous solution of carbonate may be, for example, heated to a temperature of 60 to 100° C. and kept for 0.1 to 5 hours to be coagulated into spherical particles having a volume-based cumulative 50% particle diameter (D50) measured by a laser diffraction/scattering particle size distribution measurement of 1 to 200 μm and a sphericity of 1.00 to 1.30.

The slurry of magnesium carbonate coagulated into spherical particles is, for example, filtered, washed with water, and dried to give spherical particles of magnesium carbonate by a method common in the art.

The magnesium carbonate particles prepared in the above method may be any of anhydrous magnesium carbonate, magnesium carbonate, and basic magnesium carbonate, and basic magnesium carbonate is preferred.

Conditions of firing spherical magnesium carbonate particles are not particularly limited as long as magnesium carbonate is thermally decomposed into magnesium oxide. For example, the temperature is preferably 1,000° C. to 1,800° C. more preferably 1,100° C. to 1,700° C. and particularly preferably 1,200° C. to 1,600° C. The time of firing varies depending on the temperature of firing, and the time is, for example, preferably 0.5 to 10 hours. If the temperature of firing is less than 1.000° C. particles are not sufficiently sintered, and when the temperature is more than 1.800° C. particles are sintered to form large aggregates. For this reason, the temperature of firing is adjusted to the above range.

Although the spherical magnesium oxide of the present invention has sufficient moisture resistance without surface treatment, the spherical magnesium oxide of the present invention may be surface-treated by a known method in order to improve the moisture resistance. The surface treatment agent used in the surface treatment of the spherical magnesium oxide of the present invention is not particularly limited, and for example, colloidal silica, a silane coupling agent, titania sol, a titanate coupling agent, a phosphorus compound. alumina sol, an aluminate coupling agent a zirconium coupling agent, and the like may be used.

Examples of silane coupling agents include vinyl trichlorosilane, vinyl trialkoxysilane, glycidoxypropyl trialkoxysilane and methacryloxypropylmethyldialkoxysilane.

Examples of titanate coupling agents include tetraisopropyl titanate, tetra n-butyl titanate, tetraoctyl titanate, tetrastearyl titanate, isopropyltriisostearoyl titanate, tetraoctylbis(ditridecylphosphite) titanate and bis(dioctylpyrophosphate)oxyacetate titanate.

The phosphorus compound is not particularly limited as long as it reacts with magnesium oxide to form a magnesium phosphate compound. Examples thereof include phosphoric acid, phosphate, and acidic phosphate esters. These may be used alone or two or more of them may be used in combination. Examples of acidic phosphate esters include isopropyl acid phosphate. 2-ethylhexyl acid phosphate, oleyl acid phosphate, methyl acid phosphate, ethyl acid phosphate, propyl acid phosphate, butyl acid phosphate, lauryl acid phosphate, and stearyl acid phosphate.

Examples of aluminate coupling agents include aluminum isopropylate, mono-sec-butoxy aluminum diisopropylate, aluminum sec-butyrate, aluminum ethyl acetoacetate diisopropylate and aluminum tris(ethylacetoacetate), and aluminum alkylacetoacetate diisopropylate.

Examples of zirconium coupling agents include n-propyl zirconate and n-butyl zirconate.

The spherical magnesium oxide of the present invention has high sphericity, excellent moisture resistance, and excellent filling properties in resin, and thus can be suitably added to resin as a useful resin filler. The spherical magnesium oxide of the present invention can be suitably used as a thermally conductive filler, a heat resistant filler, a gas barrier filler, and a light resistant filler, and is particularly suitable as a thermally conductive filler.

Examples of resins that can be used in the present invention include a thermosetting resin and a thermoplastic resin. Examples of thermosetting resins include, but are not limited to, a phenol resin, a urea resin, a melamine resin, an alkyd resin, a polyester resin, an epoxy resin, a diallylphthalate resin, a polyurethane resin, and a silicone resin. Examples of thermoplastic resins include, but are not limited to, a polyamide resin, a polyacetal resin, a polycarbonate resin, a polybutylene terephthalate resin, a polyolefin resin, a polysulfone resin, a polyamide-imide resin, a polyether imide resin, a polyarylate resin, a polyphenylene sulfide resin, a polyether ether ketone resin, a fluoro resin, and a liquid crystal polymer.

The amount of the spherical magnesium oxide to be mixed in the resin composition of the present invention may be determined depending on properties required for the resin composition, and the amount is not particularly limited. The spherical magnesium oxide may be used, for example, in an amount ranging from 0.1 to 100 parts by mass based on 100 parts by mass of the resin.

The resin composition containing the spherical magnesium oxide of the present invention may be used in various fields depending on the properties of the resin.

### EXAMPLES

The present invention will be described in detail with reference to Examples, but these Examples do not limit the present invention in any sense.

### <Measurement Method and Evaluation Method>

### (1) Method for Measuring Content of Elements

The content of elements was measured by ICP atomic emission spectrophotometry. The measurement sample was added to and completely dissolved in acid, and the content of the respective elements was measured by using an ICP spectrometer (PS3520 VDD made by Hitachi High-Tech Science Corporation). In the following Tables 1 and 2, when the content of an element was less than the detection limit, the content was regarded as trace amount, and described as <1 ppm.

### (2) Method for Measuring BET Specific Surface Area

The BET specific surface area was measured by using a specific surface area analyzer (Macsorb made by Mountech Co. Ltd.) by a gas adsorption method using nitrogen gas (BET method).

(3) Volume-Based Cumulative 50% Particle Diameter (D50) 0.1×10⁻³ kg of the measurement sample was precisely weighed and dispersed in 40 mL of methanol. The volume-based cumulative 50% particle diameter (D50) was measured by a laser diffraction/scattering particle size distribution analyzer (MT3300 made by Nikkiso Co., Ltd.).
(4) Sphericity and Surface Smoothness Read from a SEM Photomicrograph

A scanning electron microscope (SEM) (JSM6510LA made by JEOL Ltd.) was used.

With respect to 100 particles in an electron photomicrograph taken, lengths of a long diameter and a short diameter passing through the center of each particle were measured, and the ratio of the long diameter/the short diameter was calculated, and the average value was determined as sphericity. Furthermore, for the condition of the surface of the spherical magnesium oxide in the electron micrograph taken by the scanning electron microscope (SEM), spherical magnesium oxide having a smooth surface with few fine particulates on the surface were rated as o, those having a smooth surface with fine particulates on the surface, or those having an uneven and non-smooth surface with few fine particulates on the surface were rated as A. and those having an uneven and non-smooth surface with fine particulates on the surface were rated as x.

### (5) Evaluation of Moisture Resistance in Constant Temperature and Humidity Test

The moisture resistance of the spherical magnesium oxide was evaluated by its weight increase percentage in a constant temperature and humidity test.

A constant temperature and humidity controller THNO40FA made by Advantec was used. The weight increase percentage of 10 g of the spherical magnesium oxide was determined after exposing it to an environment of 85° C. 85% RH for 168 hours.

### EXAMPLE 1

Magnesium nitrate hexahydrate (made by Kanto Chemical Co., Ltd., special grade) was dissolved in ion exchange water to give an aqueous solution of magnesium nitrate having a concentration of about 20% by mass. Potassium carbonate (made by Kanto Chemical Co., Ltd., special grade) was dissolved in ion exchange water to give an aqueous solution of potassium carbonate having a concentration of about 15% by mass. Magnesium carbonate was synthesized by reacting the aqueous solution of magnesium nitrate and the aqueous solution of potassium carbonate with the ion concentration [Mg²⁺]: [CO₃²⁻] of 1:1. After the reaction the magnesium carbonate slurry was heated to 90° C. and kept for 1 hour to prepare a slurry of spherical magnesium carbonate. Silicon dioxide (made by Kanto Chemical Co., Ltd., special grade) was added thereto so that the content of silicon in the spherical magnesium oxide finally obtained was 2.500 ppm, and then the resultant was filtered, washed with water and dried to give spherical magnesium carbonate particles. The resulting spherical magnesium carbonate particles were fired at 1.500° C. for 1 hour in an electric furnace to give spherical magnesium oxide particles. The spherical magnesium carbonate particles before firing had a particle size (D50) of 20.5 μm and a sphericity of 1.12.

### EXAMPLE 2

Spherical magnesium oxide was prepared in the same manner as in Example 1 except for adding silicon dioxide (made by Kanto Chemical Co., Ltd., special grade) so that the content of silicon in the spherical magnesium oxide finally obtained was 5.000 ppm. The spherical magnesium carbonate particles before firing had a particle size (D50) of 20.3 μm and a sphericity of 1.12.

### EXAMPLE 3

Spherical magnesium oxide was prepared in the same manner as in Example 1 except for adding aluminum oxide (made by Kanto Chemical Co., Ltd., cica special grade) so that the content of aluminum in the spherical magnesium oxide finally obtained was 2.500 ppm instead of adding silicon dioxide. The spherical magnesium carbonate particles before firing had a particle size (D50) of 20.2 μm and a sphericity of 1.13.

### EXAMPLE 4

Spherical magnesium oxide was prepared in the same manner as in Example 1 except for adding titanium oxide (made by Kanto Chemical Co., Ltd., anatase-type, cica first grade) so that the content of titanium in the spherical magnesium oxide finally obtained was 7,500 ppm instead of adding silicon dioxide. The spherical magnesium carbonate particles before firing had a particle size (D50) of 20.5 μm and a sphericity of 1.13.

### COMPARATIVE EXAMPLE 1

Spherical magnesium oxide was prepared in the same manner as in Example 1 except for adding no silicon dioxide. The spherical magnesium oxide particles before firing had a particle size (D50) of 19.8 μm and a sphericity of 1.12.

### <Results>

The spherical magnesium oxides of Examples 1 to 4 and Comparative Example 1 were measured and evaluated as described above. The results are shown in the following Table 1. The contents of the elements belonging to the 3rd to 4th periods of the periodic table other than those shown in Table 1 was all 10 ppm or less. The content of the yttrium element was 10 ppm or less.

TABLE 1

| | | | | | Comparative |
|---|---|---|---|---|---|
| | Example 1 | Example 2 | Example 3 | Example 4 | Example 1 |
| Aluminum content (ppm) | 3 | 4 | 2,523 | 10 | 4 |
| Silicon content (ppm) | 2,509 | 5,080 | 10 | 28 | 11 |
| Titanium content (ppm) | <1 | <1 | <1 | 7,435 | <1 |
| Boron content (ppm) | <1 | <1 | 2 | <1 | <1 |
| Lithium content (ppm) | <1 | <1 | <1 | <1 | <1 |
| Calcium content (ppm) | 21 | 23 | 34 | 18 | 25 |
| D₅₀ (μm) | 14.7 | 14.1 | 13.9 | 15.2 | 12.5 |
| BET specific surface area | 0.31 | 0.30 | 0.58 | 0.20 | 22.20 |
| (m²/g) | | | | | |
| Humidity resistance (weight | 2.14 | 1.72 | 6.86 | 1.02 | 40.90 |
| increase %) | | | | | |
| Sphericity | 1.04 | 1.05 | 1.10 | 1.05 | 1.29 |
| Surface condition | ◯ | ◯ | ◯ | ◯ | X |

As is clear from Table 1, the spherical magnesium oxides of Examples 1 to 4 have excellent sphericity and excellent humidity resistance. By contrast, the spherical magnesium oxide of Comparative Example has poor sphericity and humidity resistance.

Spherical magnesium oxides of Examples 5 to 9 were also prepared as described below, and measured and evaluated in the same manner as in Examples 1 to 4 and Comparative Example 1.

### EXAMPLE 5

Spherical magnesium oxide was prepared in the same manner as in Example 1 except for adding silicon dioxide (made by Kanto Chemical Co., Ltd., special grade) so that the content of silicon in the spherical magnesium oxide finally obtained was 700 ppm, and setting the temperature of firing to 1.600° C.

### EXAMPLE 6

Spherical magnesium oxide was prepared in the same manner as in Example 1 except for adding silicon dioxide (made by Kanto Chemical Co., Ltd., special grade) so that the content of silicon in the spherical magnesium oxide finally obtained was 11.500 ppm, and setting the temperature of firing to 1.600° C.

### EXAMPLE 7

Spherical magnesium oxide was prepared in the same manner as in Example 1 except for adding sodium tripolyphosphate (made by Kanto Chemical Co., Ltd., cica first grade) so that the content of phosphorus in the spherical magnesium oxide finally obtained was 1.200 ppm instead of adding silicon dioxide, and setting the temperature of firing to 1.600° C.

### EXAMPLE 8

Spherical magnesium oxide was prepared in the same manner as in Example 1 except for adding manganese chloride tetrahydrate (made by Kanto Chemical Co., Ltd., special grade) so that the content of manganese in the spherical magnesium oxide finally obtained was 9.000 ppm instead of adding silicon dioxide, and setting the temperature of firing to 1.600° C.

### EXAMPLE 9

Spherical magnesium oxide was prepared in the same manner as in Example 1 except for adding yttrium nitrate hexahydrate (made by Kanto Chemical Co., Ltd., high purity reagent) silicon dioxide so that the content of yttrium in the spherical magnesium oxide finally obtained was 4.500 ppm instead of adding, and setting the temperature of firing to 1.600° C.

### <Results>

The spherical magnesium oxides of Examples 5 to 9 were measured and evaluated in the same manner as in Examples 1 to 4 and Comparative Example 1. The results are shown in the following Table 2. The contents of the elements belonging to the 3rd to 4th periods of the periodic table other than those shown in Table 2 was all 10 ppm or less.

TABLE 2

| | Example 5 | Example 6 | Example 7 | Example 8 | Example 9 |
|---|---|---|---|---|---|
| Aluminum content (ppm) | 136 | 79 | 8 | 21 | 11 |
| Silicon content (ppm) | 649 | 11618 | 23 | 27 | 32 |
| Titanium content (ppm) | <1 | <1 | <1 | <1 | <1 |
| Boron content (ppm) | <1 | <1 | <1 | <1 | <1 |
| Lithium content (ppm) | <1 | <1 | <1 | <1 | <1 |
| Calcium content (ppm) | 9 | 21 | 23 | 11 | 258 |
| Phosphorus content (ppm) | <1 | <1 | 1139 | <1 | <1 |
| Manganese content (ppm) | <1 | <1 | <1 | 8457 | <1 |
| Yttrium content (ppm) | <1 | <1 | <1 | <1 | 4524 |
| D₅₀ (μm) | 18.8 | 19.9 | 24.6 | 20.4 | 16.8 |
| BET specific surface area | 0.12 | 0.16 | 0.09 | 0.11 | 0.11 |
| (m²/g) | | | | | |
| Humidity resistance (weight | 1.12 | 1.34 | 4.56 | 1.42 | 2.95 |
| increase %) | | | | | |
| Sphericity | 1.07 | 1.03 | 1.03 | 1.06 | 1.05 |
| Surface condition | ◯ | ◯ | ◯ | ◯ | ◯ |

As is clear from Table 2, the spherical magnesium oxides of Examples 5 to 9 have high sphericity and excellent humidity resistance.

The above results show that the spherical magnesium oxide of the present invention has high sphericity and excellent humidity resistance. Thus, the spherical magnesium oxide of the present invention is useful as an excellent resin filler.

### INDUSTRIAL APPLICABILITY

The spherical magnesium oxide of the present invention has high sphericity and excellent humidity resistance and thus is useful as an excellent resin filler.

1. Spherical magnesium oxide having the total content of elements belonging to the 3rd to 4th periods of the periodic table (except for the elements belonging to the 2nd and 18th groups) and yttrium of 500 to 12,000 ppm, having a volume-based cumulative 50% particle diameter (D50) measured by a laser diffraction/scattering particle size distribution measurement of 1 to 200 μm, and wherein a sphericity read from a SEM photomicrograph of 1.00 to 1.20.

2. Spherical magnesium oxide having the total content of elements belonging to the 3rd to 4th periods of the periodic table (except for the elements belonging to the 2nd and 18th groups) of 500 to 12,000 ppm, having a volume-based cumulative 50% particle diameter (D50) measured by a laser diffraction/scattering particle size distribution measurement of 1 to 200 μm, and wherein a sphericity read from a SEM photomicrograph of 1.00 to 1.20.

3. The spherical magnesium oxide according to claim 1, wherein the elements belonging to the 3rd to 4th periods of the periodic table is at least one selected from the group consisting of sodium, aluminum, silicon, phosphorus, chlorine, potassium, and titanium.

4. The spherical magnesium oxide according to claim 1, wherein the content of boron is less than 10 ppm.

5. The spherical magnesium oxide according to claim 1, wherein the content of lithium is less than 15 ppm.

6. The spherical magnesium oxide according to claim 1, wherein the content of calcium is less than 700 ppm.

7. The spherical magnesium oxide according to claim 1, having a cumulative 50% particle diameter (D50) of 5 to 100 μm.

8. The spherical magnesium oxide according to claim 1, having a BET specific surface area of 0.01 to 1.00 m²/g.

9. A resin filler comprising the spherical magnesium oxide according to claim 1.

10. A resin composition comprising the resin filler according to claim 9.

11. A method for producing spherical magnesium oxide, comprising: 1) preparing a slurry of spherical magnesium carbonate by reacting an aqueous solution of magnesium salt and an aqueous solution of carbonate and coagulating the resulting magnesium carbonate; 2) preparing spherical magnesium carbonate particles by filtering the slurry of spherical magnesium carbonate, washing with water, and drying; and 3) preparing spherical magnesium oxide by firing the spherical magnesium carbonate particles, wherein in at least one of 1) to 3), the amount of each element belonging to the 3rd to 4th periods of the periodic table (except for the elements belonging to the 2nd and 18th groups) and yttrium is adjusted so that the total content of the elements belonging to the 3rd to 4th periods of the periodic table (except for the elements belonging to the 2nd and 18th groups) and yttrium is 500 to 12,000 ppm in the spherical magnesium oxide after firing.

12. A method for producing a spherical magnesium oxide, comprising: 1) preparing a slurry of spherical magnesium carbonate by reacting an aqueous solution of magnesium salt and an aqueous solution of carbonate and coagulating the resulting magnesium carbonate; 2) preparing spherical magnesium carbonate particles by filtering the slurry of spherical magnesium carbonate, washing with water, and drying; and 3) preparing a spherical magnesium oxide by firing the spherical magnesium carbonate particles, wherein in at least one of 1) to 3), the amount of each element belonging to the 3rd to 4th periods of the periodic table (except for the elements belonging to the 2nd and 18th groups) is adjusted so that the total content of the elements belonging to the 3rd to 4th periods of the periodic table (except for the elements belonging to the 2nd and 18th groups) is 500 to 12,000 ppm in the spherical magnesium oxide after firing.

13. The spherical magnesium oxide according to claim 2, wherein the elements belonging to the 3rd to 4th periods of the periodic table is at least one selected from the group consisting of sodium, aluminum, silicon, phosphorus, chlorine, potassium, and titanium.

14. The spherical magnesium oxide according to claim 2, wherein the content of boron is less than 10 ppm.

15. The spherical magnesium oxide according to claim 2, wherein the content of lithium is less than 15 ppm.

16. The spherical magnesium oxide according to claim 2, wherein the content of calcium is less than 700 ppm.

17. The spherical magnesium oxide according to claim 2, having a cumulative 50% particle diameter (D50) of 5 to 100 μm.

18. The spherical magnesium oxide according to claim 2, having a BET specific surface area of 0.01 to 1.00 m²/g.

19. A resin filler comprising the spherical magnesium oxide according to claim 2.

20. A resin composition comprising the resin filler according to claim 19.
